(19) United States
(12) Patent Application Publication
(10) Pub. No.: US 2005/0186971 A1
(43) Pub. Date: Aug. 25, 2005

(54) Method and apparatus for intelligent paging in a wireless communication network

(75) Inventors: Dipankar Ray, Plano, TX (US); Sven Anders Borje Svensson, San Diego, CA (US)

Correspondence Address: COATS & BENNETT, PLLC, P O BOX 5, RALEIGH, NC, 27602, US

(73) Assignee: Telefonaktiebolaget L M Ericsson

(21) Appl. No.: 11/013,857

(22) Filed: Dec. 16, 2004

Related U.S. Application Data
(60) Provisional application No. 60/546,582, filed on Feb. 20, 2004.
(60) Provisional application No. 60/546,581, filed on Feb. 20, 2004.

(51) Int. Cl. H04Q 7/20

(52) U.S. Cl. 455/456.5; 455/426.1

(57) ABSTRACT

A Base Station Controller (BSC) in a wireless communication network stores paging location information for a mobile station, and uses that information to determine whether paging the mobile station for mobile-terminated packet data delivery requires mobile switching center (MSC) involvement. For example, the BSC may send a service request message to the MSC to initiate paging of the mobile station by the MSC if the paging location information identifies a service area that is not exclusive to the BSC, and autonomously page the mobile station if the identified service area is exclusive to the BSC. Also, the BSC may autonomously page the mobile station along with sending a service request to the MSC, on the chance that the mobile station actually is within a service area controlled by the BSC. The BSC also may send a service request to the MSC if autonomous paging fails.

### RELATED APPLICATIONS

The instant application claims priority under 35 U.S.C. § 119(e) from the U.S. provisional patent application filed on 20 Feb. 2004, entitled “MSC Independent Packet Data,” and assigned Application Ser. No. 60/546,582, and also claims priority to U.S. provisional patent application filed on 20 Feb. 2004, entitled “Intelligent Paging for Packet Data Call,” and assigned Application Ser. No. 60/546,581. This application expressly incorporates the contents of the '582 and '581 provisional applications by reference herein.

### BACKGROUND OF THE INVENTION

The present invention generally relates to wireless communication networks, and particularly relates to intelligent paging methods and apparatus that reduce the involvement of Mobile Switching Centers (MSCs) in paging mobile stations for packet data calls.

Wireless communication networks eventually will move to an all-IP configuration and the current distinctions between “circuit-switched” and “packet-switched” call types will disappear. For the foreseeable future, however, many types of wireless communication networks include entities primarily associated with supporting “legacy” circuit-switched services, and entities primarily associated with supporting packet-switched services. Some network entities are involved in supporting both types of services and these entities can represent processing “bottlenecks” with respect to supporting the developing range of packet data services.

For example, wireless networks based on the IS-95 CDMA standards used MSCs to support certain connection management functions, including paging mobile stations for mobile-terminated packet data calls. The network-initiated reactivation of a dormant mobile station for delivery of packet data in such networks typically involves signaling between a base station controller and a MSC, resulting in paging of the mobile station by the MSC.

However, the MSC's involvement does not extend to carrying or routing the packet data, it merely provides paging services (for reactivation) and authentication services as needed. Indeed, involving the MSC in the reactivation paging functions associated with packet call delivery may undesirably add time to call setup, particularly if the processing load on the MSC is already high. Thus, eliminating or at least reducing the involvement of MSCs in network-initiated packet delivery may provide performance advantages and call setup simplifications.

### SUMMARY OF THE INVENTION

The present invention comprises a method and apparatus for intelligent paging of mobile stations in a wireless communication network supporting packet data services, wherein base stations retain location information for dormant mobile stations and provide paging services for those mobile stations in at least some circumstances. Providing paging services at the base station level eliminates or reduces the involvement of Mobile Switching Centers (MSCs) in packet data call setup, thereby reducing call setup times, as well as reducing processing overhead at the MSCs.

In one embodiment, a Base Station Controller (BSC) for use in a wireless communication network implements a method of paging a mobile station for network-initiated packet data delivery. That method comprises storing paging location information for the mobile station, and sending a service request message to a MSC to initiate paging of the mobile station by the MSC if the paging location information identifies a service area that is not exclusively associated with the BSC. The BSC may attempt autonomous paging along with initiating MSC-based paging, on the chance that the mobile station is within an area under control by the BSC. If the service area identified by the paging location information is exclusive to the BSC, then the BSC autonomously pages the mobile station. If autonomous paging fails, the BSC may initiate MSC-based paging.

Thus, the BSC carries out BSC-based (autonomous) paging to reactivate dormant mobile stations for network-initiated packet delivery when appropriate, but leaves open possibility of carrying out the more conventional, MSC-based paging process. Carrying out BSC-based (autonomous) paging of mobile stations reduces the need for the more conventional MSC-based paging of mobile stations. Reducing the MSC's involvement in reactivating (dormant) mobile stations for network-initiated packet data delivery generally reduces call setup times and reduces the processing load at the MSC.

In one or more embodiments, a BSC is configured to carry out the above method, or to carry out one or more variations of that method. Such a BSC comprises one or more processing circuits configured to store paging location information for the mobile station, send a service request message to a MSC to initiate paging of the mobile station by the MSC if the paging location information identifies a service area that is not exclusively associated with the BSC, and autonomously page the mobile station if the paging location information identifies a service area that is exclusively associated with the BSC.

The one or more processing circuits may be configured to autonomously page the mobile station in addition to sending the service request message to the MSC, which may speed up reactivation of the mobile station on the chance that the mobile station receives the BSC's autonomous paging message(s). Further, the processing circuit(s) may be configured to initiate MSC-based paging if autonomous paging fails. The BSC may maintain one or more timers used to track the elapsed time after paging, such that expiration of a defined period without receiving a page response is deemed a paging failure.

Of course, the present invention's selective use of BSC-based and MSC-based paging of mobile stations is not limited to the above features and advantages. Those skilled in the art will recognize additional features and advantages upon reading the following detailed description, and upon viewing the accompanying figures.

### BRIEF DESCRIPTION OF THE DRAWINGS

FIG. 1 is a block diagram of a wireless communication network, including one or more BSCs configured for selective BSC-based or MSC-based mobile station paging.

FIG. 2 is a block diagram of wireless network cells or sectors grouped into paging areas identified by Location Area Codes (LACs), or the like.

FIG. 3 is a block diagram of the network of FIG. 1 that illustrates several network entities in more detail.

FIG. 4 is a logic flow diagram of BSC logic implementing a paging process that provides for autonomous (BSC-based) mobile station paging and non-autonomous (MSC-based) paging as needed or desired.

FIG. 5 is a call flow diagram of autonomous paging.

FIG. 6 is a call flow diagram of non-autonomous paging.

### DETAILED DESCRIPTION OF THE INVENTION

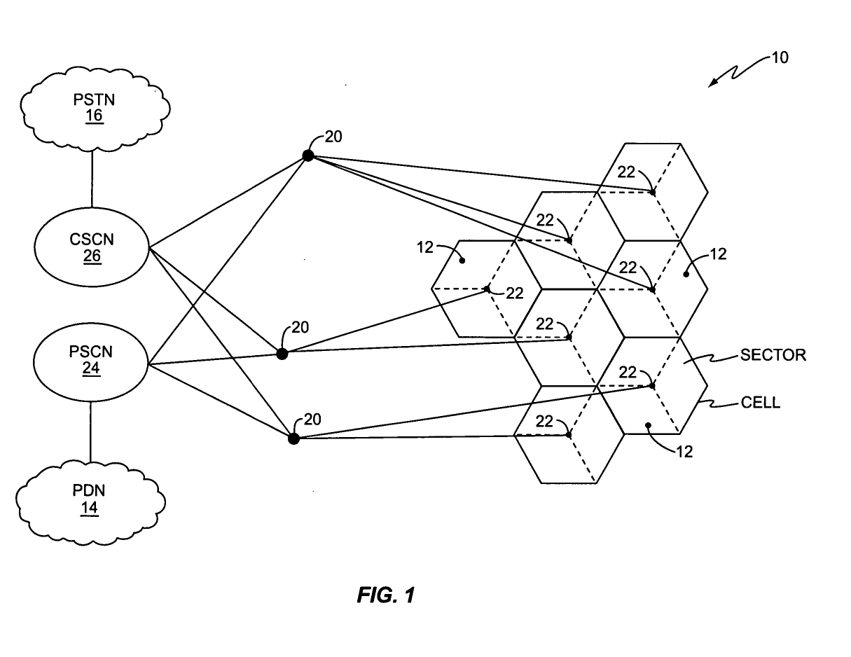

FIG. 1 illustrates a cdma2000-based wireless communication network 10 according to one or more embodiments of the present invention. The network 10 communicatively couples mobile stations 12 to one or more Public Data Networks (PDNs) 14, such as the Internet, and to the Public Switched Telephone Network (PSTN) 16. By way of non-limiting example, the network 10 may comprise a cdma2000 cellular communication network, and it should be understood that some of the entity names and one or more of the network's architectural details may vary depending upon the specific communication standards on which the network 10 is based. For example, the network 10 may be configured according to the GSM/GPRS wireless communication standards, the W-CDMA wireless communication standards, etc.

With that in mind, the illustrated network 10 comprises a Radio Access Network (RAN) that includes Base Station Controllers (BSCs) 20, each controlling one or more Radio Base Stations (RBSs) 22, a Packet Switched Core Network (PSCN) 24 communicatively coupled to the PDN 14 (e.g., the Internet), and a Circuit Switched Core Network (CSCN) 26 communicatively coupled to the PSTN 16. The RAN may comprise many BSCs 20 and associated RBSs 22, and generally provides radio service over one or more contiguous or non-contiguous geographic areas using one or more Radio Frequency (RF) carriers.

In particular, the illustrated network 10 uses a cell/sector configuration, wherein each RBS 22 defines a cell site providing radio coverage in each of a plurality of radio sectors. The RBSs 22 may include “sectorized” radio transceiver circuits and corresponding per-sector antenna elements to provide the illustrated sectorized radio coverage. By way of non-limiting example, each RBS 22 defines a three-sector radio cell corresponding to defined geographic service areas generally having overlapping boundaries with adjacent sectors/cells. Thus, each BSC 20 “controls” one or more given portions of the network's aggregate service area. In one or more embodiments, the specific service area controlled by each BSC 20 corresponds to the combined coverage areas of its RBSs 22.

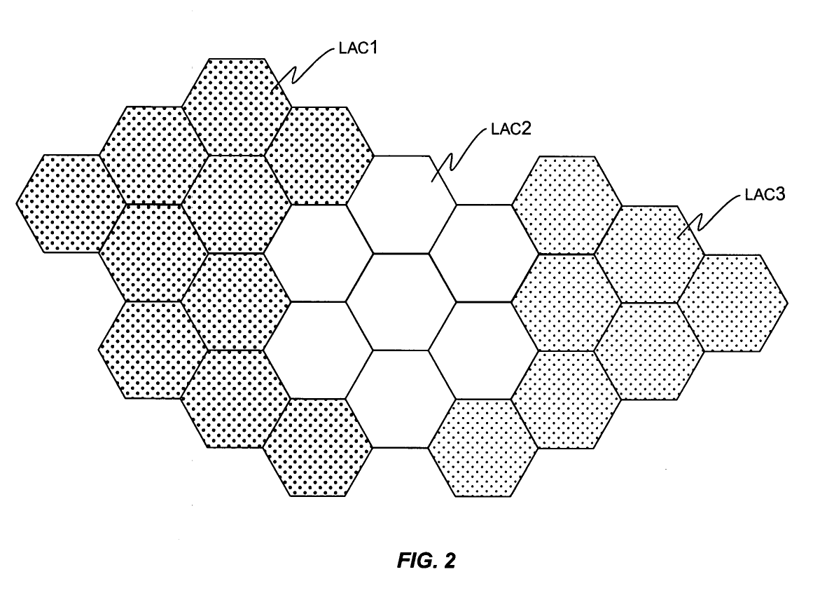

Those BSC coverage areas do not necessarily correspond to the “paging areas” that may be defined by the network 10. FIG. 2 illustrates a collection of cells within the network 10 that are divided into paging areas, identified by unique Location Area Codes, or other similar identification numbers. Generally, the location areas corresponding to the defined LACs comprise sets of cells designated by the network operator and signify the smallest area within the network 10 in which page requests are sent.

While not germane to understanding autonomous paging by BSCs as taught herein, LACs can be formed based on identification numbers associated with each cell. Such numbers may comprise Cell Global Identities, or CGIs. While the service area (cells, sectors, etc.) identified by a given LAC may coincidentally correspond to the service area covered by one BSC 20, there generally is no requirement that the paging service areas correspond to BSC service areas because the paging service areas are meant to aid the paging process (searching for given targeted mobile stations), while the BSC service areas are defined by the geographic and physical layout of the RBSs 22 and relate to traffic connections and radio resources. Thus, a given paging service area may comprise regions under the exclusive control of a single BSC 20, or may comprise regions corresponding to two or more BSCs 20. Evaluating such distinctions is useful in determining when and how to conduct BSC-based autonomous paging as an alternative to, or as a supplement to, MSC-based non-autonomous paging.

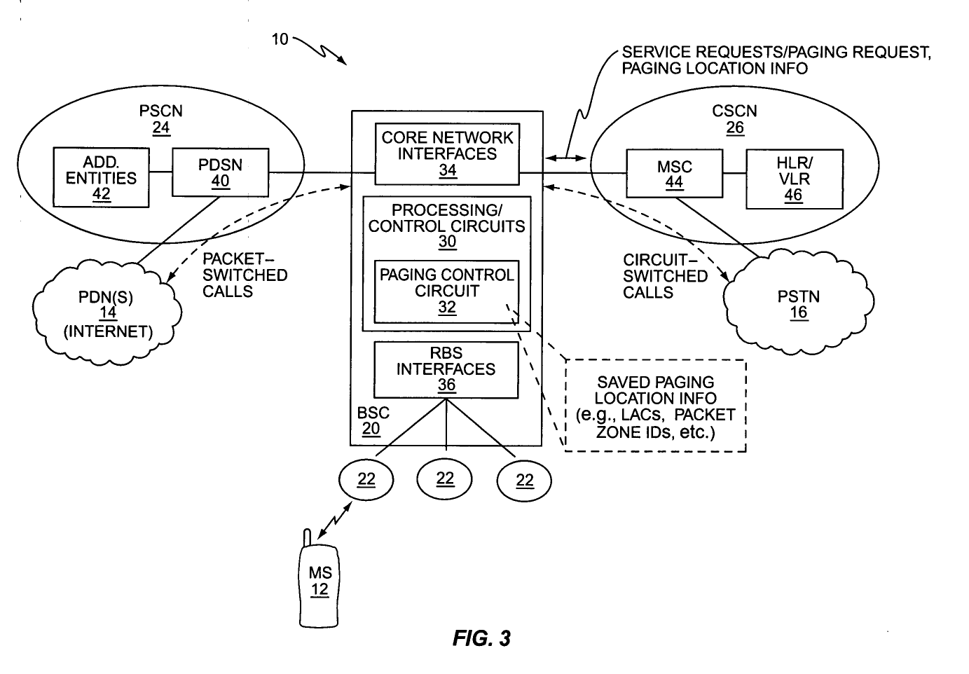

FIG. 3 illustrates the network 10 in more detail, and particularly illustrates one embodiment of a BSC 20 configured for operation in the network 10, which, as stated, may comprise a cdma2000-based wireless communication network. Thus, BSC 20 may be configured as a cdma2000 base station and operate according to the various protocols and procedures defined by the relevant standards.

The illustrated BSC 20 comprises processing/control circuits 30 including one or more processing circuits configured for operation as a paging control circuit 32, core network interface circuits 34, and RBS interface circuits 36. The core interface circuits 34 may include Packet Control Function (PCF) circuits providing a Radio-Packet (RP) interface with a Packet Data Serving Node (PDSN) 40 included in the PSCN 24. The PDSN 40 anchors the Point-to-Point Protocol (PPP) data connections established and maintained for mobile stations 12 engaged in packet data services, and provides routing to the appropriate PCF/BSC pairs for packet data incoming to the network 10 that is targeted for delivery to particular ones of the mobile stations 12. The PSCN 24 may include one or more additional entities 42 associated with location-based services, authentication, etc.

While not involved in actually carrying the packet data traffic, elements of the CSCN 26 generally are involved in at least some aspects of packet data call setup and delivery. The illustrated CSCN 26 comprises an MSC 44 and a Home Location Register (HLR)/Visitor Location Register (VLR) 46, and may comprise additional entities not illustrated. In particular, the MSC 44 is involved in many packet data call setup and delivery functions, and potentially significant connection management signaling may flow between the BSC 20 and the MSC 44 for packet data calls, despite the MSC 44 not being directly involved in packet data traffic delivery.

Indeed, as noted in the co-pending and commonly assigned U.S. patent application entitled “METHOD AND APPARATUS TO REDUCE MOBILE SWITCHING CENTER INVOLVEMENT IN PACKET DATA CALL SUPPORT,” filed in the U.S. Patent and Trademark Office on 10 Dec. 2004, and identified by Attorney Docket No. 4740-375/P19242-US2, the involvement of the MSC 44 in packet data call management is undesirable. That application, which is incorporated in its entirety herein by reference, discusses in more detail the various reasons for involving MSCs in packet data call handling.

In one or more embodiments described herein, the BSC 20 is configured to reduce the involvement of MSCs, at least for paging (dormant) mobile stations 12 in support of network-initiated packet data delivery. That is, in response to recognizing the need for reactivating a dormant mobile station 12 to support delivery of a mobile-terminated packet data call, the BSC 20 autonomously pages the mobile station 12 without involving the MSC 44, at least in circumstances where autonomous paging is appropriate. Autonomous paging stands in contrast to the conventional reactivation process for dormant mobile stations, wherein incoming packet data for a mobile station 12 triggers service request messaging between the PCF (not illustrated) and the BSC 20, which causes the BSC 20 to send a message to the MSC 44, thereby initiating MSC-based paging of the mobile station. In contrast, autonomous paging by the BSC 20 avoids the involvement of the MSC 44, thereby potentially reducing packet data call setup times, and lessening the processing burden imposed on the MSC 44 for packet data call processing.

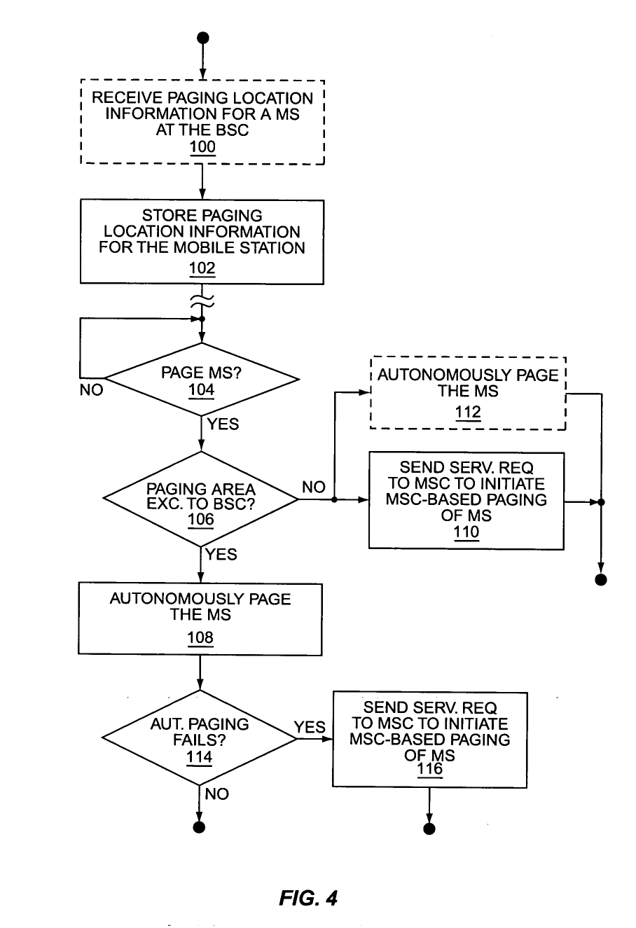

FIG. 4 steps through the processing logic needed to implement one embodiment of autonomous paging, wherein the BSC 20 receives paging location information for a given mobile station 12 (Step 100). The one or more processing circuits configured for operation as the paging control circuit 32 may include one or more memory/storage elements, or be associated with such elements, that are used to store the paging location information for the mobile station 12. (Those skilled in the art will appreciate that the BSC 20 can support autonomous paging for a plurality of mobile stations 12, and thus may store paging location information for each such mobile station 12.)

The BSC 20 generally receives the paging location information from the MSC 44 during call setup, when the mobile station 12 goes dormant, as part of handoff into the BSC's service area, or at some other time while the mobile station 12 is active in a packet data call. The paging location information identifies the paging service area associated with the mobile station 12, and may comprise a LAC as explained above. The paging service area may correspond to the area(s) under control of the BSC 20, or may include areas under the control of other BSCs 20.

Note, too, that the paging location information may comprise a “Packet Zone Identifier,” or the like, which corresponds to a given packet zone within the network 10. Oftentimes, such packet zones are defined by the service “footprint” of the Packet Control Functions (PCFs) that interface the BSCs 20 to the PSCN 24. Thus, the BSC 20 can be configured to carry out autonomous paging, non-autonomous paging, or some combination thereof, based on determining whether the paging location information stored for the mobile station 12 defines a packet zone that includes only service areas under the BSC's control, or includes service areas associated with one or more other BSCs 20. If the circuitry comprising the PCF is co-located with the BSC 20, then the packet zone footprint of the PCF generally matches the radio service footprint of the BSC, however, packet zone footprints may be defined to encompass the service areas of multiple BSCs 20.

In any case, the BSC 20 stores the paging location information for the mobile station 12 for later use in autonomous/non-autonomous paging control (Step 102). (Note that the BSC 20 may update or clear the paging location information responsive to receiving a subsequent message from the MSC 44, or from another network entity. For example, the BSC 20 may clear the stored paging location information if the mobile station's allowed dormancy period expires, if the mobile station leaves the BSC's service area, e.g., undergoes dormant handoff to another area, etc.)

If paging is not required, the BSC 20 goes on with whatever processing is required by its ongoing operations (Step 104). However, if paging is required, the BSC 20 evaluates the paging location information stored for the mobile station 12. Paging will be required, for example, if the mobile station 12 went dormant within the BSC's service area and subsequent reactivation of the mobile station 12 is required for network-initiated packet delivery.

To carry out the reactivation paging, the BSC 20 evaluates the paging location information stored for the mobile station 12 (Step 106). In one or more embodiments, that evaluation comprises determining whether the service area(s) identified by the paging location information are exclusive to the BSC 20, or are non-exclusive, i.e., involve areas outside of the BSC's control. If the service area identified by the paging location information corresponds to the BSC's service area, the BSC 20 autonomously pages the mobile station 12 (Step 108). In this context, the term “autonomous paging” denotes the BSC sending a page to the mobile station 12 in one or more of the BSC's radio sectors without needing the involvement or support of the MSC 44.

If the service area identified by the paging location information covers more than just the BSC's service area—i.e., is not exclusive to the BSC 20—then the BSC 20 sends a service request message to the MSC 44 to initiate MSC-based paging of the mobile station 110. Note that the BSC 20 may carry out autonomous paging along with initiating MSC-based paging on the chance that the mobile station 12 actually is in the BSC's exclusive service area. The benefit of autonomous paging is that it is generally faster than MSC-based paging because it does not require messaging between the BSC 20 and the MSC 44, and therefore can provide faster setup of the packet data call.

Note, too, that the BSC 20 can be configured to use MSC-based paging in case BSC-based autonomous paging fails, i.e., fails to solicit a response from the mobile station 12 within the allowed period of paging response time. Specifically, if the autonomous paging fails (Step 114), the BSC 20 sends a service request to the MSC 44 to initiate MSC-based paging of the mobile station 12 (Step 116). The advantage of MSC-based paging is that it covers the whole paging location service area, including those areas outside the BSC's control. Thus, a flood page by the MSC 44 reaches more than just the BSC's service area, and may reach the mobile station 12 in instances where the autonomous page did not.

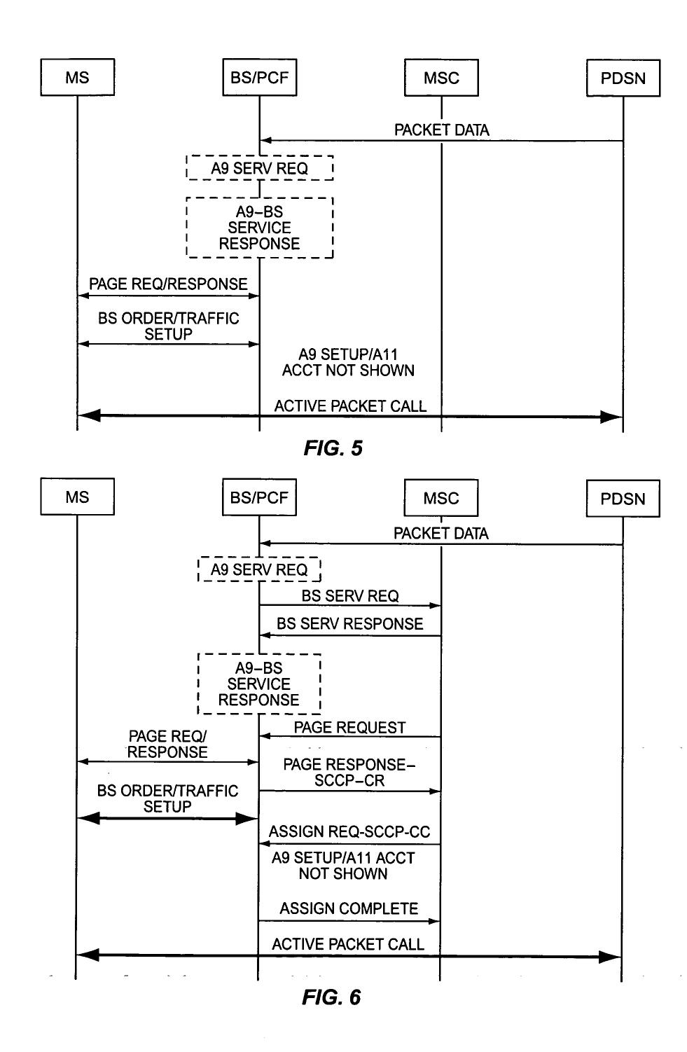

FIGS. 5 and 6 illustrate the call flows associated autonomous paging (FIG. 5) and non-autonomous paging (FIG. 6). In FIG. 5, the PDSN 40 receives incoming packet data—i.e., a mobile-terminated packet data call—for a targeted mobile station 12. Generally, the PDSN 40 is unaware of the mobile station's connection state (active, dormant, etc.), and thus simply forwards the data to the PCF associated with the appropriate BSC 20. The delivery of packet data to the PCF causes it to generate a service request message (e.g., an “A9 Service Request” according to IS-2000 standards) that is sent to the BSC 20. BSC 20 generates a service response message for the PCF, and autonomously generates a page request for the targeted mobile station 12. Assuming that it receives a page response from the mobile station 12, the BSC then allocates resources for the packet data call as needed, e.g., it allocates traffic channel resources to the mobile station 12. Note that the BSC 20 can be configured to perform the allocation of resources autonomously as well, thereby eliminating the need for connection management signaling with the MSC 44, which is conventionally required for packet call setup.

In FIG. 6, one sees that receipt of the PCF's service request at the BSC 20 results in the BSC 20 initiating MSC-based paging of the mobile station 12 based on generating a service request message—e.g., a “BS Service Request” message according to IS-2000 standards—and sending that message to the MSC 44. Of course, as highlighted in the discussion of FIG. 4, the BSC 20 can be configured to incorporate call flow steps from both FIGS. 5 and 6 by performing BSC-based and MSC-based paging in selected circumstances.

With the above embodiments in mind, those skilled in the art should appreciate that the present invention broadly contemplates a BSC 20 that is configured for operation in a wireless communication network, and that particularly is configured to reduce the involvement of MSCs 44 in the paging process used to reactivate dormant mobile stations for network-initiated packet data delivery. The BSC 20 reduces that involvement by autonomously paging mobile stations 12 without MSC involvement if the paging location information stored for a targeted mobile station 12 identifies service area(s) directly corresponding to the BSC's service area. Of course, if the paging location service area includes areas outside the BSC's control, the BSC 20 can initiate MSC-based paging in addition to autonomous paging, or as an alternative to it.

Autonomous paging efficiency can be improved by the BSC 20 sending the page request from those radio sectors under its control that are deemed the most likely possible locations of the mobile station 12. If that selective autonomous paging is not successful, the BSC 20 can autonomously page the mobile station 12 from all radio sectors under its control. If that autonomous flood paging is unsuccessful, the BSC 20 can initiate MSC-based paging, wherein the MSC 44 has the capability to initiate paging outside of the BSC's service area. It is expected that the mobile station will respond to the first page it receives, thus sending autonomous and non-autonomous pages, or sending autonomous pages from different radio sectors at different times, is not problematic.

As such, it should be understood that the present invention is not limited by the foregoing discussion of one or more of its embodiments, nor is it limited by the accompanying drawings. Indeed, the present invention is limited only by the following claims and their legal equivalents.

1. At a Base Station Controller (BSC) for use in a wireless communication network, a method of paging a mobile station for network-initiated packet data delivery, the method comprising:
storing paging location information for the mobile station;
sending a service request message to a Mobile Switching Center (MSC) to initiate paging of the mobile station by the MSC if the paging location information identifies a service area that is not exclusively associated with the BSC; and
autonomously paging the mobile station if the paging location information identifies a service area that is exclusively associated with the base station controller.

2. The method of claim 1, further comprising autonomously paging the mobile station in addition to sending the service request message to the MSC.

3. The method of claim 1, further comprising sending a service request message to the MSC to initiate paging of the mobile station by the MSC if the autonomous paging fails.

4. The method of claim 1, wherein the BSC is configured for operation in a cdma2000-based wireless communication network.

5. The method of claim 1, wherein the paging location information comprises a Location Area Code (LAC) that identifies a service area comprising one or more radio sectors or cells of the wireless communication network.

6. The method of claim 1, further comprising receiving the paging location information for the mobile station from the MSC.

7. The method of claim 1, further comprising updating or clearing the paging location information responsive to receiving an indication that the mobile station has undergone a dormant handoff.

8. The method of claim 1, further comprising, if the mobile station responds to the autonomous paging by the BSC and authentication of the mobile station by the MSC is not required, autonomously allocating traffic channel resources at the BSC as needed for delivering packet data to the mobile station.

9. The method of claim 1, wherein autonomously paging the mobile station comprises selectively paging the mobile station in one or more radio sectors determined as the most likely current location of the mobile station and, if the selective paging fails, flood paging the mobile station in all radio sectors associated with the BSC.

10. The method of claim 9, wherein selectively paging the mobile station in one or more radio sectors determined as the most likely current location of the mobile station comprises paging the mobile station in those radio sectors corresponding to a pilot list received for the mobile station in association with a prior call attempt.

11. A method of reducing the involvement of Mobile Switching Centers (MSCs) in paging mobile stations for mobile-terminated packet data calls, the method comprising:
receiving a packet data service request at a Base Station Controller (BSC) for a dormant mobile station, said BSC being associated with a supporting MSC; and
autonomously paging the mobile station if paging location information stored at the BSC for the mobile station identifies a service area exclusively associated with the BSC.

12. The method of claim 11, further comprising informing the MSC of the packet data service request to initiate paging of the mobile station by the MSC, if the autonomous paging fails.

13. The method of claim 11, further comprising, if the paging location information identifies a service area that is exclusively associated with the BSC, informing the MSC of the packet data service request to initiate paging of the mobile station by the MSC in conjunction with autonomously paging the mobile station.

14. A Base Station Controller (BSC) for use in a wireless communication network, said BSC comprising one or more processing circuits configured to:
store paging location information for the mobile station;
send a service request message to a Mobile Switching Center (MSC) to initiate paging of the mobile station by the MSC if the paging location information identifies a service area that is not exclusively associated with the BSC; and
autonomously page the mobile station if the paging location information identifies a service area that is exclusively associated with the BSC.

15. The BSC of claim 14, wherein the one or more processing circuit are further configured to autonomously page the mobile station in addition to sending the service request message to the MSC.

16. The BSC of claim 14, wherein the one or more processing circuits are further configured to send a service request message to the MSC to initiate paging of the mobile station by the MSC if the autonomous paging fails.

17. The BSC of claim 14, wherein the BSC is configured for operation in a cdma2000-based wireless communication network.

18. The BSC of claim 14, wherein the paging location information comprises a Location Area Code (LAC) that identifies one or more radio sectors or cells of the wireless communication network.

19. The BSC of claim 14, wherein the BSC is configured to receive the paging location information for the mobile station from the MSC.

20. The BSC of claim 14, wherein the one or more processing circuits are configured to update or clear the paging location information responsive to receiving an indication that the mobile station has undergone a dormant handoff.

21. The BSC of claim 14, wherein the BSC is further configured to autonomously allocate traffic channel resources at the BSC as needed for delivering packet data to the mobile station, if the mobile station responds to the autonomous paging by the BSC and authentication of the mobile station by the MSC is not required for allocating the traffic channel resources.

22. The BSC of claim 14, wherein the one or more processing circuits are configured to autonomously page the mobile station by selectively paging the mobile station in one or more radio sectors determined as the most likely current location of the mobile station and, if the selective paging fails, flood paging the mobile station in all radio sectors associated with the BSC.

23. The method of claim 22, wherein the one or more processing circuits are configured to selectively page the mobile station by paging the mobile station in those radio sectors corresponding to a pilot list received for the mobile station in association with a prior call attempt.
